(19) United States
(12) Patent Application Publication
(10) Pub. No.: US 2026/0147851 A1
(43) Pub. Date: May 28, 2026

(54) Elliptical Partial Differential Equation Solver for Computational Fluid Dynamics

(71) Applicant: Board of Regents, The University of Texas System, Austin, TX (US)

(72) Inventor: Kiran Bhaganagar, San Antonio, TX (US)

(21) Appl. No.: 19/400,862

(22) Filed: Nov. 25, 2025

Related U.S. Application Data
(60) Provisional application No. 63/724,625, filed on Nov. 25, 2024.

(51) Int. Cl. G06F 17/13; G06F 30/27; G06F 30/28; G06F 113/08

(52) U.S. Cl. CPC G06F 17/13; G06F 30/27; G06F 30/28; G06F 2113/08

(57) ABSTRACT

Computer systems and methods for training a neural network model to model the dynamical behavior of a fluid. The neural network model is trained based on a network configuration and using a training dataset. The neural network is trained for a plurality of layers that exhibit a ramping down of a spatial resolution between layers followed by a ramping up of the spatial resolution between layers. A test dataset is received representing mathematical characteristics of an elliptical partial differential equation describing dynamical aspects of the fluid. The elliptical partial differential equation is numerically solved using the trained neural network model to determine a solution of the elliptical partial differential equation. The dynamical behavior of the fluid is determined based at least in part on the solution of the elliptical partial differential equation. The dynamical behavior of the fluid is stored in a non-transitory computer-readable memory medium.

### PRIORITY CLAIM

This application claims the benefit of priority to U.S. Patent Application Ser. No. 63/724,625, filed Nov. 25, 2024, entitled “Elliptical Partial Differential Equation Solver for Computational Fluid Dynamics”, which is incorporated herein by reference in its entirety as though completely set forth herein.

### BACKGROUND

### Technical Field

Fluid dynamics is a complex field of physics that is fundamental to understanding and predicting the behavior of liquids and gases in various environments and applications. Traditional computational fluid dynamics (CFD) methods involve solving the Navier-Stokes equations, which can be computationally intensive and time-consuming, especially for systems with complex geometries or turbulent flows. As a result, there is an increasing demand for innovative approaches that can accelerate fluid behavior analysis while maintaining high accuracy. The advent of machine learning techniques has opened new avenues for modeling and simulating fluid flows. In particular, neural networks have shown promise due to their ability to approximate non-linear functions and make predictions based on learned data. However, conventional neural network models often lack the capability to adapt to the spatial variations inherent in fluid dynamical systems, leading to a trade-off between model complexity and computation efficiency. Thus, more robust modeling approaches are desirable that are capable of dynamically adapting to local flow characteristics in order to provide precise fluid dynamic behavior predictions with reduced computational overhead.

### Description of the Related Art

Deep learning methods such as Convolutional Neural Networks (CNNs) have emerged as powerful techniques for solving partial differential equations (PDEs). Deep learning is an attractive alternative to the conventional approach in which the mathematical PDE is posed as a matrix equation and numerical algorithms using either direct methods or iterative methods are implemented to solve the resultant matrix equation. Direct solvers are computationally and memory intensive as they involve the inversion of the matrix. Accordingly, they are more suitable for smaller systems and also for well-conditioned matrices. Iterative solvers are suited for larger systems. However, the accuracy of both direct and iterative methods depends on the condition of the matrix, and an ill-conditional matrix may be prone to significant errors. Hence, the high computational cost and issues with the ill-conditioning of the resultant matrices is a key impediment for the numerical solution of PDEs through conventional methods. Considering the relevance of PDE's to the numerical solution of Navier-Stokes equations, there has been a significant surge of interest in using Neural Networks for solving them. Accordingly, improvements in the field are desired.

### SUMMARY

Embodiments described herein relate to computer systems and methods for training a neural network model to model the dynamical behavior of a fluid.

In some embodiments, a network configuration is received for training a neural network model.

In some embodiments, the neural network model is trained using a training dataset. Training the neural network may be performed for a plurality of layers, wherein a first layer of the plurality of layers receives a set of initial conditions of the fluid as input and outputs a first output. Each layer of the plurality of layers after the first layer may receive as input an output of a preceding layer.

In some embodiments, the plurality of layers exhibit a ramping down of a spatial resolution between layers followed by a ramping up of the spatial resolution between layers. Each layer during the ramping down of the spatial resolution may provide features to a corresponding layer with a same spatial resolution during the ramping up of the spatial resolution.

In some embodiments, a test dataset is received representing mathematical characteristics of an elliptical partial differential equation describing dynamical aspects of the fluid.

In some embodiments, the elliptical partial differential equation is numerically solved using the trained neural network model to determine a solution of the elliptical partial differential equation.

In some embodiments, the dynamical behavior of the fluid is determined based at least in part on the solution of the elliptical partial differential equation.

In some embodiments, the determined dynamical behavior of the fluid is stored in a non-transitory computer-readable memory medium.

This Summary is intended to provide a brief overview of some of the subject matter described in this document. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 is a block diagram of a computing system, according to some embodiments;

FIG. 2 is a flowchart diagram illustrating a computer-implemented method for determining the dynamical behavior of a fluid, according to some embodiments;

FIG. 3 illustrates a V-cycle of a multigrid neural network with 5 grid levels, according to some embodiments;

FIGS. 4A-C illustrate U-Net Architectures for a neural network with various parameter values, according to some embodiments;

FIG. 5 illustrates the workflow for the proposed U-Net architecture, according to some embodiments;

FIGS. 6A-C illustrate training data for the Poisson equation, according to some embodiments;

FIG. 7 illustrates exact and numerical solutions for the Poisson equation using the Jacobi method, according to some embodiments;

FIG. 8 illustrates exact and numerical solutions for the Helmholtz equation using the Jacobi method, according to some embodiments;

FIG. 9 is a plot of mean squared error of the residue vs. computational cost for different U-Net configurations for a Poisson solver, according to some embodiments; and

FIG. 10 is a plot of mean squared error of the residue vs. computational cost for different U-Net configurations for a Helmholtz solver, according to some embodiments.

Although the embodiments disclosed herein are susceptible to various modifications and alternative forms, specific embodiments are shown by way of example in the drawings and are described herein in detail. It should be understood, however, that drawings and detailed description thereto are not intended to limit the scope of the claims to the particular forms disclosed. On the contrary, this application is intended to cover all modifications, equivalents and alternatives falling within the spirit and scope of the disclosure of the present application as defined by the appended claims.

This disclosure includes references to “one embodiment,” “a particular embodiment,” “some embodiments,” “various embodiments,” or “an embodiment.” The appearances of the phrases “in one embodiment,” “in a particular embodiment,” “in some embodiments,” “in various embodiments,” or “in an embodiment” do not necessarily refer to the same embodiment. Particular features, structures, or characteristics may be combined in any suitable manner consistent with this disclosure.

Reciting in the appended claims that an element is “configured to” perform one or more tasks is expressly intended not to invoke 35 U.S.C. § 112 (f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors.

As used herein, the terms “first,” “second,” etc. are used as labels for nouns that they precede, and do not imply any type of ordering (e.g., spatial, temporal, logical, etc.), unless stated otherwise. As used herein, the term “or” is used as an inclusive or and not as an exclusive or. For example, the phrase “at least one of x, y, or z” means any one of x, y, and z, as well as any combination thereof (e.g., x and y, but not z). In some situations, the context of use of the term “or” may show that it is being used in an exclusive sense, e.g., where “select one of x, y, or z” means that only one of x, y, and z are selected in that example.

In the following description, numerous specific details are set forth to provide a thorough understanding of the disclosed embodiments. One having ordinary skill in the art, however, should recognize that aspects of disclosed embodiments might be practiced without these specific details. In some instances, well-known, structures, computer program instructions, and techniques have not been shown in detail to avoid obscuring the disclosed embodiments.

### DETAILED DESCRIPTION

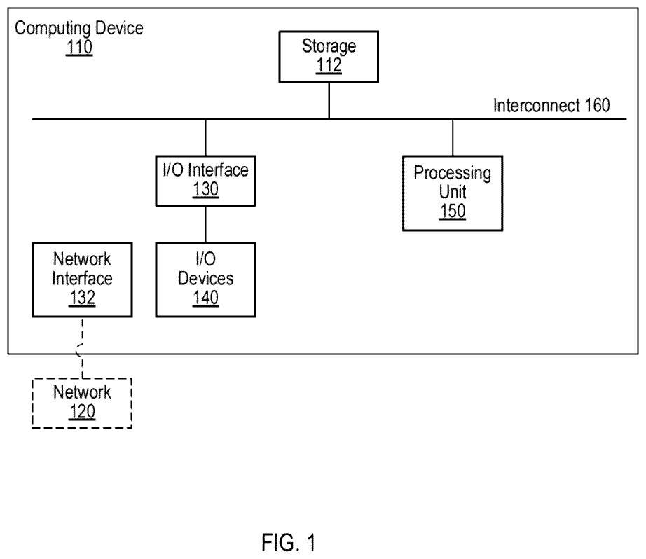

### FIG. 1—Example Computer System

FIG. 1 is a block diagram of one embodiment of computing device (which may also be referred to as a computing system) 110 is depicted, which may be utilized in accordance with some embodiments. The computing device 110 may be used to implement various portions of this disclosure. Computing device 110 may be any suitable type of device, including, but not limited to, a personal computer system, desktop computer, laptop or notebook computer, mainframe computer system, web server, workstation, or network computer. As shown, computing device 110 includes processing unit 150, storage 112, and input/output (I/O) interface 130 coupled via an interconnect 60 (e.g., a system bus). I/O interface 130 may be coupled to one or more I/O devices 140. Computing device 110 further includes network interface 132, which may be coupled to network 120 for communications with, for example, other computing devices.

In various embodiments, processing unit 150 includes one or more processors. In some embodiments, processing unit 150 includes one or more coprocessor units. In some embodiments, multiple instances of processing unit 150 may be coupled to interconnect 160. Processing unit 150 (or each processor within 150) may contain a cache or other form of on-board memory. In some embodiments, processing unit 150 may be implemented as a general-purpose processing unit, and in other embodiments it may be implemented as a special purpose processing unit (e.g., an ASIC). In general, computing device 110 is not limited to any particular type of processing unit or processor subsystem.

As used herein, the term “module” refers to circuitry configured to perform specified operations or to physical non-transitory computer readable media that store information (e.g., program instructions) that instructs other circuitry (e.g., a processor) to perform specified operations. Modules may be implemented in multiple ways, including as a hardwired circuit or as a memory having program instructions stored therein that are executable by one or more processors to perform the operations. A hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Storage 112 is usable by processing unit 150 (e.g., to store instructions executable by and data used by processing unit 150). Storage 112 may be implemented by any suitable type of physical memory media, including hard disk storage, floppy disk storage, removable disk storage, flash memory, random access memory (RAM-SRAM, EDO RAM, SDRAM, DDR SDRAM, RDRAM, etc.), ROM (PROM, EEPROM, etc.), and so on. Storage 112 may consist solely of volatile memory, in one embodiment. Storage 112 may store program instructions executable by computing device 110 using processing unit 150, including program instructions executable to cause computing device 110 to implement the various techniques disclosed herein.

I/O interface 130 may represent one or more interfaces and may be any of various types of interfaces configured to couple to and communicate with other devices, according to various embodiments. In one embodiment, I/O interface 130 is a bridge chip from a front-side to one or more back-side buses. I/O interface 130 may be coupled to one or more I/O devices 140 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. The computing system may execute the instructions using one or more processing elements. The articles of manufacture include non-transitory computer-readable memory media. The contemplated non-transitory computer-readable memory media include portions of a memory subsystem of a computing device as well as storage media or memory media such as magnetic media (e.g., disk) or optical media (e.g., CD, DVD, and related technologies, etc.). The non-transitory computer-readable media may be either volatile or nonvolatile memory.

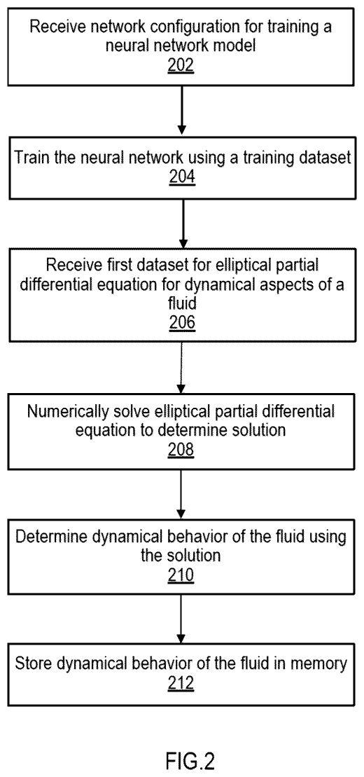

### FIG. 2—Flowchart for Determining Dynamical Fluid Behavior

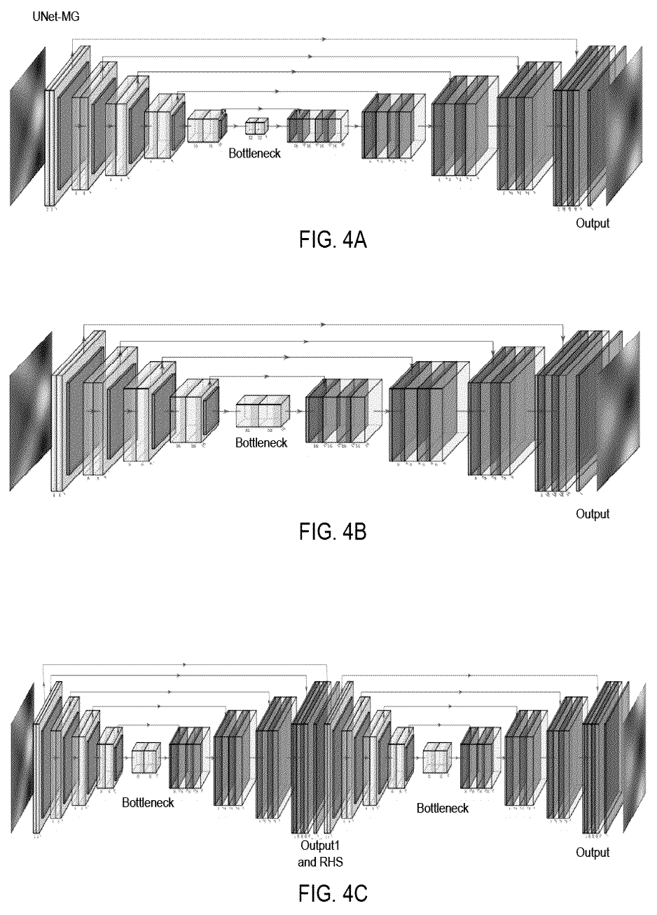

FIG. 2 is a flowchart diagram illustrating a method for training and operating a neural network model to determine the dynamical behavior of a fluid, according to some embodiments. The fluids considered can be compressible or incompressible and may exhibit laminar or turbulent flow, as indicated by the Reynold's number. Understanding such flows is critical in applications like air flow over vehicles or aircraft, liquid flow through pipes, or atmospheric layer movement over land. In some embodiments, the neural network may include a plurality of neurons in a plurality of layers, where neurons in adjacent layers are connected by a plurality of weights. For example, the method shown in FIG. 2 may operate using a neural network similar to the network illustrated in FIG. 4, which illustrates several examples of U-net architectures.

The method shown in FIG. 2 may be used in conjunction with any of the computer systems, memory media and/or devices shown in the above Figures, among other devices. In some embodiments, a computer system may include a processor and memory, and the memory may store program instructions executable by the processor to perform the method elements described in reference to FIG. 2. In various embodiments, the processor may be a parallel multi-processor system, a field programmable gate array (FPGA), or an application specific integrated circuit (ASIC).

In some embodiments, the described method steps may be directed by one or more processors of a computer system, such as the example computing system shown in FIG. 1. In various embodiments, some of the method elements shown may be performed concurrently, in a different order than shown, or may be omitted. Additional method elements may also be performed as desired. As shown, this method may operate as follows.

At 202, a network configuration for training a neural network model is received. The network configuration may include one or more parameters, including but not limited to an initial features parameter ƒ, a stack parameter s, a number of scale changes d, a parametrized pooling function, and a type of activation function. Aspects of these parameters are described in greater detail below. The neural network may be configured according to the received network configuration.

At 204, the neural network model is trained using a training dataset. The neural network model may include a plurality of sequential layers, and the initial layer receives as input the initial conditions of the fluid and produces an output. Subsequent layers take the output of the preceding layer as input. In some embodiments, the layers demonstrate a reduction in spatial resolution followed by an increase in spatial resolution. During the downward phase, each layer transfers features to a corresponding upward layer with the same spatial resolution. This feature transfer, also referred to as a “skip connection”, is illustrated in FIG. 4 as connecting arrows between layers, and transfers information from the down-ramp (encoding) phase to a corresponding layer in the up-ramp (decoding) phase. Said another way, subsequent layers process outputs from preceding layers, utilizing a unique method where the spatial resolution decreases and then increases across the layers. During this transition, each layer in the ramping down phase supports feature sharing with a corresponding layer at an equivalent spatial resolution during the ramping up phase. In some embodiments, training the neural network model includes minimizing a mean-squared error (MSE) loss function, which aggregates a loss over pixels in the training dataset.

By employing series of nested, dense skip connections within the encoder-decoder framework, semantic loss between feature mappings is minimized, allowing each layer to fully exploit extracted features for enhanced representation power. Further refinements enable adaptive pooling techniques like average pooling, replacing conventional max pooling to distribute weighted features uniformly across layers, enhancing accuracy. For example, training the neural network model may include implementing an average pooling function on features extracted for each layer of the plurality of layers.

In some embodiments, the plurality of layers further exhibits at least one second ramping down of the spatial resolution between layers followed by at least one second ramping up of the spatial resolution between layers. These additional layers exhibiting multiple cycles of spatial resolution changes may aid in capturing varied dynamic behaviors. An example of this type of neural network configuration is shown in FIG. 4C, with two instances of ramping up and ramping down.

In some embodiments, training the neural network model using the training dataset is performed according to a plurality of U-net architectures. For example, each of a plurality of different network configurations may be received, and the training process may be separately performed for each of these network configurations. The training dataset may include a randomized set of waves with a plurality of distinct frequencies in a periodic domain, ensuring comprehensive representation of potential fluid dynamics scenarios.

Further, the trained neural network may be trained to determine features and behaviors of the elliptical operator, rather than solving the entire equation, at each layer. Said another way, rather than training the neural network to directly obtain the solution the elliptical PDE, the neural network is trained to output a representation of the elliptical operator, effectively modelling the behavior of the elliptical operator. Existing V-net cycle techniques are required to rerun the simulation for each distinct set of initial conditions. Because embodiments herein model the behavior of the elliptical operator, the trained neural network may be applied to a variety of different initial conditions without having to retrain the neural network.

Previous implementations solved the ePDE for each of a plurality of different resolutions at each layer. In contrast, embodiments herein extracts features of the behavior of the elliptical operator at each of a plurality of resolutions at each layer. As described in greater detail below, feature extraction for the behavior of the elliptical operator may be performed by minimizing a loss function at each resolution. The loss function may be obtained by training the neural network with training data that includes known sets of data ƒ and solutions u.

At 206, a test dataset is received that represents mathematical characteristics of an elliptical partial differential equation describing dynamical aspects of the fluid. The elliptical partial differential equation may be a Poisson equation or a Helmholtz equation, and the Poisson equation may be a pressure Poisson equation for an incompressible or compressible fluid. Note that the neural network model is first developed with a training dataset. Subsequently, an additional “test dataset” is utilized to validate the accuracy of the model that has been developed. This two stage process may prevent overfitting of the model. Note that the training dataset and the test dataset may be similar, but they are utilized for different purposes in developing the neural network.

The test dataset embodies mathematical properties relevant to elliptical partial differential equations, which are critical in characterizing fluid dynamics. This dataset serves as an input for numerically solving the equations involved, thereby enabling the analysis of dynamic fluid behaviors using the trained neural network model. The test dataset may be obtained by assigning a random seed to each element of the training dataset, in some embodiments.

At 208, the elliptical partial differential equation is numerically solved by leveraging the trained neural network model to determine a solution. This step utilizes the resolution-accommodating structure of the neural network to compute the fluid's dynamics accurately. By resolving equations such as the Poisson or Helmholtz equations, the trained neural network effectively extracts and represents multi-scale features at each layer, enabling an understanding of fluid behavior across different length scales.

In some embodiments, the computing system employs a trained neural network to numerically solve an elliptic partial differential equation, such as the Poisson or Helmholtz equation, and, in doing so, automatically performs multi-scale feature extraction across its internal layers. When the neural network is presented with input fields associated with the elliptic operator, the network computes the solution by enforcing the governing differential relationships-specifically the spatial gradients and Laplacian terms of the elliptic equation. As these constraints propagate through the network during training and inference, each layer forms latent representations that correspond to distinct physical length scales of the solution, including fine-scale variations, intermediate harmonic structures, and global, low-frequency solution modes. This hierarchical representation enables the neural network to accommodate different spatial resolutions and accurately recover the fluid or physical field behavior across the domain. Thus, by solving the elliptic PDE internally and on a multi-scale basis, the neural network inherently extracts and encodes multi-scale physical features at each depth of the architecture, providing a resolution-adaptive numerical model that captures both local and global characteristics of the underlying fluid dynamics.

The solution derived from solving elliptical partial differential equations captures multi-scale features of their elliptical operator counterparts. Each layer intricately extracts these features at its respective spatial resolution, facilitating detailed analysis. In some embodiments, the solution of the elliptical partial differential equation is a numerical description of multi-scale features of an elliptical operator of the elliptical partial differential equation. Each layer of the plurality of layers may extract features of the elliptical operator of the elliptical partial differential equation at a respective spatial resolution of the respective layer.

At 210, the dynamical behavior of the fluid is determined based at least in part on the solution of the elliptical partial differential equation. This may be performed by analyzing the results derived from numerically solving the elliptical partial differential equation. This analysis enables a detailed understanding of how the fluid behaves dynamically under specified conditions. By applying the trained neural network model to solve these equations, it is possible to predict fluid movement and characteristics accurately, taking into account both compressible and incompressible fluids and scenarios involving turbulent flows. The outcomes may provide essential insights into practical applications such as vehicle aerodynamics and atmospheric phenomena over land surfaces, enabling efficient simulation and evaluation of complex fluid interactions.

Elliptic partial differential equations arise naturally in fluid mechanics because several fundamental fluid quantities, such as pressure fields, potential flow fields, vorticity transport, and diffusion-dominated processes are governed by elliptic operators. In incompressible and low-Mach fluid flows, the pressure field is determined by enforcing mass conservation, which reduces to a Poisson-type elliptic equation linking pressure to the spatial gradients of velocity. Similarly, irrotational or potential flows satisfy Laplace's equation, an elliptic form that fully characterizes the velocity potential throughout the fluid domain. Elliptic PDEs also describe diffusion-controlled behavior, including the smoothing of velocity, temperature, or concentration fields when advective effects are weak. Because solutions to elliptic equations depend on the global configuration of the domain and its boundary conditions, they inherently capture both local variations and long-range interactions present in fluid systems. As a result, solving an elliptic PDE can yield a complete spatial description of a fluid's internal state, which in turn enables the derivation and prediction of fluid behavior across all relevant length scales.

The dynamical behavior of the fluid may describe a variety of physical scenarios, including but not limited to a flow of air over a terrestrial vehicle or aircraft, a flow of a liquid through a pipe, or a flow of one or more atmospheric layers over land (e.g., reflecting the natural interaction between atmospheric layers and terrestrial surfaces).

At 212, the determined dynamical behavior of the fluid is stored in a non-transitory computer-readable memory medium. Outputs generated from this system consist of dynamic behavior profiles stored onto non-transitory computer-readable storage media, facilitating easy retrieval for analysis or further research applications. Ultimately, this neural network model redefines possibilities within computational fluid dynamics by merging high-fidelity numerical modeling approaches with state-of-the-art neural architectures to solve PDEs efficiently and accurately, opening pathways for more advanced applications in scientific and engineering realms.

### Additional Technical Description

The following numbered paragraphs provide additional information related to the described embodiments.

### Navier-Stokes Formulations

The governing equations to simulate incompressible turbulent flows are the Navier-Stokes equations. The incompressible N-S equations are the continuity equation (or the conservation of mass) and time-dependent conservation of momentum equations (See. Eq. 1, below). The 3-D numerical solution of the four coupled equations solves the four unknowns (p (pressure), u₁, u₂, u₃ (components of velocity along the x₁, x₂, x₃ directions). The most common approach of solving the N-S equations is using the velocity-pressure formulation, which is also known as the primitive-variable formulation. In this approach, the incompressibility constraint (Continuity equation) is replaced by a pressure Poisson equation (Eq. 2, below). The alternate approach is to eliminate the pressure in the N-S equation by taking the curl of the N-S equations resulting in the governing equation for vorticity. A more elegant formulation is taking the curl-curl of the N-S equations resulting in a governing equation for the vertical velocity and vertical vorticity (See Eq. 3). By using either the vorticity formulation or the vertical-velocity vertical-vorticity formulation, the Pressure and velocity components can be determined once these derived variables are known. An advantage of using the alternate formulation is it eliminates pressure in the governing equation. This is beneficial as it is not straight forward to obtain the pressure boundary conditions, and this may lead to numerical and physical errors in the solution. The numerical scheme for the solution of the incompressible Navier-Stokes equations based on either the primitive variable formulation or the alternate formulations results in a Poisson or Helmholtz-type elliptical equation (as shown in Eq. 6). Essentially, a robust solution of the Elliptical Poisson and Helmholtz equations dictates the overall solution of the discretized N-S equations.

The governing equations in the non-dimensional form are as follows:

$$\frac{\partial {u}_{i}}{\partial {x}_{i}} = 0 \qquad ( 1 )$$

$$\frac{\partial {u}_{i}}{\partial t} + {u}_{j} \frac{\partial {u}_{i}}{\partial {x}_{j}} = \frac{1}{Re} \frac{{\partial }^{2} {u}_{i}}{\partial {x}_{j} {x}_{j}} - \frac{\partial p}{\partial {x}_{j}}$$

where, uᵢ i=1, 2, 3 are the three components of velocity, the Laplacian is

$$Δ = \frac{{\partial }^{2}}{\partial {x}_{j} {x}_{j}} = \frac{\partial }{\partial {x}_{1}^{2}} + \frac{\partial }{\partial {x}_{2}^{2}} + \frac{\partial }{\partial {x}_{3}^{2}} ,$$

the Del operator is

$$∇ = \frac{\partial }{\partial {x}_{i}} ,$$

is the non-dimensional Reynolds number, and p is the pressure. By taking the divergence of the momentum equation, the resultant equation for pressure is obtained, which is the Pressure Poisson equation, namely,

$$\frac{{\partial }^{2} P}{\partial {x}_{j} {x}_{j}} = - \frac{\partial {u}_{i}}{\partial {x}_{j}} \frac{\partial {u}_{i}}{\partial {x}_{j}} \qquad ( 2 )$$

By solving the Elliptical Pressure Poisson equation (Eq. 2) and the momentum equations (Eq. 1), the solution for the velocity and pressure are obtained. The main disadvantage of this approach is a lack of straight-forward boundary conditions for the pressure

An alternative approach for solving the Navier-Stokes Equation is by taking the curl of the curl of the equations resulting in an equation for the normal component of the velocity and another equation for the normal component of the vorticity. The equations are as follows:

$$\frac{\partial {ω}_{2}}{\partial t} = {H}_{ω} + \frac{{\partial }^{2} {ω}_{2}}{\partial {x}_{j} {x}_{j}} \qquad ( 3 )$$

$$\frac{\partial Δ {u}_{2}}{\partial t} = {H}_{{u}_{2}} + {Δ}^{2} {u}_{2}$$

$$Here ,$$

$${H}_{{u}_{2}} = - \frac{\partial }{\partial {x}_{2}} [ \frac{\partial {H}_{1}}{\partial {x}_{1}} + \frac{\partial {H}_{3}}{\partial {x}_{3}} ] + [ \frac{{\partial }^{2}}{\partial {x}_{1}^{2}} + \frac{{\partial }^{2}}{\partial {x}_{3}^{2}} ] {H}_{2} , \qquad ( 4 )$$

$${H}_{ω} = \frac{\partial {H}_{3}}{\partial {x}_{1}} + \frac{\partial {H}_{1}}{\partial {x}_{3}}$$

$$H = ( {H}_{1} , {H}_{2} , {H}_{3} ) = ux ω$$

For numerical simplicity the fourth-order vertical velocity is split into two second-order equations as follows:

$$\frac{\partial ϕ}{\partial t} = {H}_{{u}_{2}} + {Δ}^{2} {u}_{2} , \qquad ( 5 )$$

$$Δ {u}_{2} = ϕ ,$$

Here, φ is the Laplacian of the vertical velocity.

The numerical integration is possible with either an explicit or an implicit time-integration scheme, and the semi-implicit time-integration uses the explicit integration for the linear terms and implicit for the nonlinear term. The resultant discretized numerical equations are of the form:

$$( I - {α}_{1} Δ ) {ω}_{2}^{n + 1} = {F}_{1} ( {ω}_{n} , {ω}_{n - 1} ) \qquad ( 6 )$$

$$( I - {α}_{2} Δ ) {ϕ}^{n + 1} = {F}_{2} ( {H}_{{u}_{2}}^{n} , {H}_{{u}_{2}}^{n - 1} )$$

$$Δ {v}^{n + 1} = {ϕ}^{n + 1} ,$$

where, F₁, F₂ are nonlinear functions and α₁ is the coefficient for the corresponding time-integration equation. This is a generalized time-discretized form of the N-S equation in the vertical velocity and vertical vorticity formulation. The resultant equations are the form of Helmholtz-(Eq. 11) and Poisson-Equations (Eq. 9).

Overall, both the primitive variable formulation and the vertical velocity-vertical vorticity formulation of the Navier-Stokes equation results in solving the Poisson- and Helmholtz-equations.

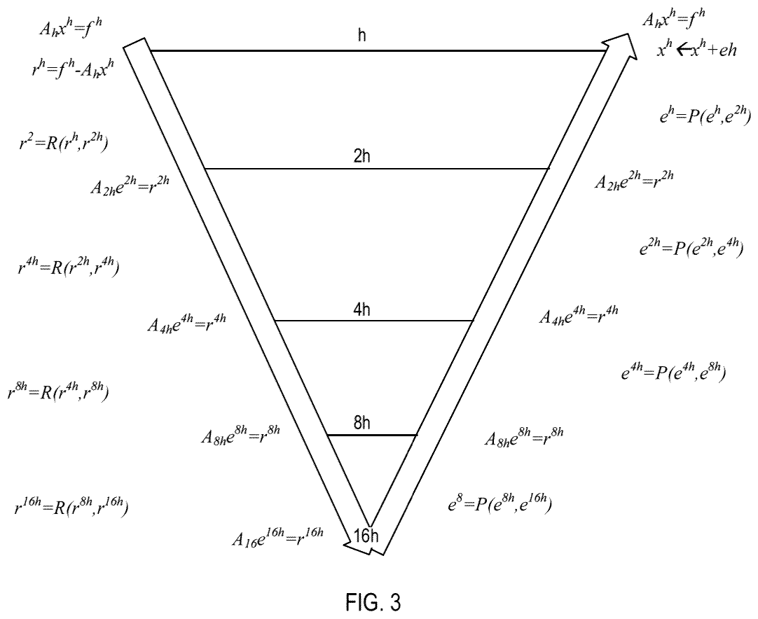

### FIG. 3—Multigrid Method

FIG. 3 illustrates a V-cycle of a multigrid with 5 grid levels. The following notation is used: Let the mesh-size of the finest grid be represented as h, and the solution, residue and the error on this grid are represented as u^{h}, r^{h} and e^{h}, respectively. This is the top-most level of the multigrid as seen in FIG. 3. At the next level, the mesh-size is 2h, where the mesh-size has been doubled. The solution, error and residue at this grid level are represented as e^{2h}, r^{2h} and e^{2h}, respectively. At the third level, the mesh-size is 4h, and the solution, error and residue at this level are represented as u^{th}, e^{th} and r^{th}, respectively. This process is repeated depending on the number of levels used. The numerical error at each grid level is measured as the two-norm of the algebraic error which is the difference of the exact and the numerical solution. The residue is the difference between the right-hand-side of the equation and the numerical approximation of the left-hand-side of the equation.

In the forward part of the V-Cycle, the smoothing of the error equation starts at the fine level and iterations are performed to achieve a desired convergence. The error and the residue are transferred to the next grid level through restriction operation. In the upward part of the V-Cycle, the error is corrected through the prolongation operation to the next grid level.

The numerical discretization of the elliptical operator can be approximated by the matrix A^{h} for the corresponding grid level, h. For the forcing function ƒ and the solution u, the elliptical equation can be represented as:

$${A}^{h} {x}^{h} = {f}^{h} \qquad ( 7 )$$

By defining the error as e^{h}=uₑ−u^{h}, uₑ as the exact solution, and the residue as r^{h}=ƒ^{h}−A^{h}u^{h}, it can be shown that the corresponding residual equation is given as:

$${A}^{h} {e}^{h} = {r}^{h} \qquad ( 8 )$$

Equation (8) may be recursively solved at each grid level using an iterative method such as Jacobi. As seen in FIG. 3, during the forward stroke of the V-cycle, the residual equation is solved, and during the backward stroke, the error is corrected to the numerical solution. Thus, the discretized elliptical equation is iteratively solved until a desired convergence is achieved. The down- and up-sampling operations are called as restriction and prolongation, and are implemented using weighted restriction and linear interpolation respectively.

### Configurable U-Net Deep Learning Architectures

A U-Net is a convolutional neural network architecture consisting of a contracting path, an expanding path, and a set of horizontal skip connections between them. The encoding layers are on the contracting path. The encoder layers perform convolutional and pooling operations that reduce the spatial resolution of the feature maps while increasing their depth, effectively trading resolution for semantic representational power. The contracting path follows the architecture of a typical convolutional network and consists of repeated applications of convolutions, each followed by activation functions and a pooling operation with stride of two for down-sampling. As the data passes down the encoder side of the network, it passes through consecutive levels where the resolution reduces by half (or another factor) at each level (producing feature maps at different strides), and the number of features doubles with each contraction.

The decoding layers are on the expanding path. In the decoder portion of the network, a series of transposed convolution operations are performed to increase the resolution, and these layers are followed by additional convolution layers at each stride. The features extracted from the encoding side of the network are forwarded to the right side by the horizontal connections, and these features are concatenated with those from the expanding path at the same stride, allowing the fine-resolution details to be forwarded through horizontal connections. The convolutional neural network (CNN) has the ability to learn a hierarchical representation of the raw input data by processing the inputs through network layers. The level of abstraction of the resulting features increases as the shallower layers grasp local information while the deeper layers use filters with much broader receptive fields to capture global information. The components of the U-Net are as follows:
Contracting Path: The contracting path has multiple building blocks of convolution layers called blocks. The contracting path consists of repeated application of two 3×3 convolutions, each followed by an activation function and a pooling operation with strides for down-sampling. The contracting path learns a hierarchy of features at varying levels of granularity.
Expansion Path: Every step in the expansive path consists of an up-sampling of the feature map followed by a 2×2 convolution that halves the number of feature channels, a concatenation with the correspondingly cropped feature map from the contracting path, and two 3×3 convolutions, each followed by an activation function. At the final layer, a 1×1 convolution is used to map the feature vector to the desired number of classes.
Skip Connections: The incorporation of skip connections facilitates the decoder in utilizing feature maps from earlier encoder layers, ensuring the preservation of spatial information and mitigating the vanishing gradient problem. These connections play a critical role in achieving accurate segmentation by allowing the network to combine low-level and high-level features.

Analogous to a V-cycle multigrid, the U-Net can be viewed as a configurable process. One can envision a family of U-Net architectures that vary in ways that are analogous to multigrid configurations. U-Net architectures may be built with different numbers of strides (analogous to grids) and may be stacked (analogous to the number of V-cycle iterations). Additionally, other aspects of the U-Net may be worth configuring to better suit the task of solving PDEs. To explore the effect of these design choices on performance (in terms of both error and computational cost), a configurable U-Net architecture has been created, enabling us to analyze a search space of architectures and hyperparameters.

Embodiments herein describe a configurable U-Net architecture, which is an advanced neural network framework designed to solve elliptic partial differential equations (PDEs) like the Poisson and Helmholtz equations, often found in computational fluid dynamics scenarios. Inspired by the success of U-Nets in image segmentation, this architecture includes a contracting path that captures features with a hierarchy of convolutions and down-samples them to increase depth, and an expansion path that up-samples to recover spatial resolution. Unique to the Configurable U-Net is its versatility, allowing for modifications in parameters such as the number of initial features, stacks, and scales.

One implementation describes an architectural framework for computational fluid dynamics that can be configured based on three main parameters: initial features, stacks, and scales.

“Initial features” refer to the number of feature channels computed in the initial layers of the U-Net architecture. This parameter influences the network's overall width and directly affects the model's ability to capture detailed information at various stages of processing.

“Stacks” denote the number of U-Net instances placed sequentially. By stacking multiple U-Nets, the architecture leverages outputs from preceding networks as additional inputs, thereby enhancing feature extraction and resolution capabilities across layers.

“Scales” indicate the number of changes in resolution within the network, similar to grid levels in multigrid methods. Each scale represents a different level of detail that the network can capture, allowing for fine-grained analysis and processing of multiscale features inherent in fluid dynamics simulations.

These configurable elements allow the architecture to be tailored for specific tasks, balancing computational cost and accuracy in solving partial differential equations such as Poisson and Helmholtz equations.

Pooling functions are configurable, where average pooling can replace max pooling based on performance needs. Max pooling uses the maximum observed values in a set of overlapping cells, having the effect of maximizing feature responses to salient details, while average pooling equally weighs neighboring features (making it analogous to the process of restriction operation in multigrid methods).

Activation functions like the exponential linear unit (ELU) or the rectified linear unit (ReLU) may be employed to improve learning dynamics and alleviate vanishing gradient issues. The ELU has been shown to improve learning compared to other activation functions in deep neural networks which leads to higher classification accuracy as they alleviate the vanishing gradient problem. In contrast to ReLU, ELU have negative values which allows them to push mean unit activation closer to zero like batch normalization but with a lower computational complexity. The mean shifts towards zero and speeds up the learning by bringing the normal gradient closer to the unit natural gradient because of a reduced bias shift effect. ELU leads not only to faster learning, but also to significantly improve the generalization performance than ReLU, for many applications.

Solving multi-scale elliptical partial differential equations involves addressing complex mathematical problems that model various physical phenomena, such as fluid dynamics. These equations often feature phenomena occurring at different scales, requiring sophisticated methods to capture both large-scale trends and fine-grained details accurately. A neural network architecture, like the U-Net, may be trained to approximate these solutions by effectively learning patterns across different spatial resolutions. The model processes inputs through multiple layers, where initial layers might capture broader patterns, and deeper layers focus on finer details. This structured approach allows the network to efficiently and accurately solve equations that traditionally demand extensive computational resources using conventional numerical techniques.

One implementation optimizes computational cost for solving Navier-Stokes equations by employing a configurable U-Net architecture. Traditional methods for solving these equations, such as multigrid techniques, are computationally intensive and resource-heavy due to their iterative nature. By integrating a deep learning framework based on U-Net, the system captures the complex multi-scale features of Navier-Stokes equations efficiently. This approach reduces the computational burden by leveraging a neural network's ability to generalize from training data, thus reducing the number of iterations needed compared to conventional numerical solvers. The result is a more efficient solution process that maintains accuracy while significantly lowering resource consumption.

One implementation integrates ideas from V-cycle multigrid methods by utilizing a hierarchical approach to enhance neural network training. In V-cycle multigrid, computations traverse various grid levels, smoothing errors on fine grids and transferring them to coarser grids for correction. Similarly, the U-Net architecture in some embodiments simulates this process. It contracts feature maps through pooling, reducing their resolution akin to down-sampling on finer grids. Subsequently, during expansion, it up-samples to restore resolution. This back-and-forth movement within the network mimics the error correction process of V-cycle multigrid, enabling efficient learning of multi-scale features in fluid dynamics. Ultimately, this approach expedites convergence and accuracy while reducing computational cost.

One implementation involves a neural network specifically trained to solve Poisson and Helmholtz equations, which are essential in modeling various physical phenomena in fluid dynamics. The method utilizes a U-Net architecture, a type of convolutional neural network known for its efficacy in image segmentation tasks. This architecture is configured to capture both low-level and high-level features of the equations through its contracting and expanding paths.

The contracting path of the U-Net reduces spatial resolution while extracting important features, whereas the expanding path restores the resolution, aiding in reconstructing the solution. Key to this approach are skip connections that merge information from different layers, preserving crucial details.

The training process employs synthetic datasets with known solutions, generated to reflect the mathematical characteristics of Poisson and Helmholtz equations and utilizing sinusoidal and cosine functions to mimic various scenarios. The network is optimized to minimize mean-squared error between predicted and actual solutions, allowing it to accurately replicate complex multi-scale features present in fluid dynamics problems.

By capturing the intricate patterns within these equations more efficiently than traditional methods, this neural network application provides a powerful computational tool for advanced fluid simulations, offering better convergence and reduced computational costs compared to conventional iterative approaches.

One implementation demonstrates improved convergence over traditional multigrid methods by utilizing a U-Net architecture that captures the mathematical features of elliptic operators more efficiently. Traditional multigrid techniques rely on hierarchical grid structures to solve PDEs by smoothing errors at different grid levels. However, they can struggle with convergence due to high-frequency errors and inadequate handling of complex multiscale features.

In contrast, the U-Net architecture excels in managing these challenges by employing a convolutional network with skip connections that allow for effective feature extraction and integration. This architecture adapts to various scales within the data, leading to faster and more accurate resolutions of the residual equations. By leveraging neural networks, the system inherently learns complex patterns within the fluid dynamics data, offering superior convergence rates compared to conventional methods. The improved efficiency stems from the ability of the U-Net to process information across scales, ensuring that both high and low-frequency errors are addressed more effectively during the simulation process.

One implementation utilizes mean-squared error (MSE) for model training by measuring the average squared difference between predicted and actual values. This error metric helps optimize the neural network during training by minimizing the discrepancy between its predictions and the true data. By focusing on reducing MSE, the model effectively learns to improve its accuracy and generalization capabilities, ensuring that it better captures complex patterns in the data related to fluid dynamics simulations.

One implementation uses the Adam solver, which is an optimization algorithm designed for training deep learning models. It efficiently adjusts learning rates for different parameters during training. By calculating adaptive learning rates, Adam provides better convergence, leading to improved performance and accuracy in neural network models.

Stacked U-Net models improve efficiency by using multiple layers of U-Net blocks, which allow for better feature extraction at various scales. This architecture capitalizes on the strengths of U-Nets in capturing both local and global features through skip connections. By stacking U-Nets, the model processes data through successive layers, enhancing its capacity to discriminate finer details while maintaining computational efficiency. The stacked structure facilitates the learning of complex patterns with fewer parameters compared to conventional methods, optimizing the trade-off between accuracy and computational cost.

One implementation utilizes synthetic data, which combines waves of different frequencies, to effectively train neural networks. This approach allows the model to learn a wide range of patterns and features within fluid dynamics simulations. By incorporating both low-frequency and high-frequency components, the synthetic dataset ensures that the neural network can generalize well across various scales and capture complex behaviors in fluid flows. This method is particularly useful for solving partial differential equations like Poisson and Helmholtz equations, enabling the network to approximate solutions with high accuracy.

One implementation utilizes a configurable U-Net architecture to accelerate the computation of multi-scale elliptic partial differential equations (PDEs). By leveraging the strengths of this architecture, computation times are significantly reduced compared to traditional methods. The U-Net's design allows it to efficiently handle the spatial complexity of the equations, resulting in faster processing speeds. Additionally, the architecture's ability to capture fine details leads to a reduction in computational errors, enhancing overall accuracy in solving fluid dynamics problems. This approach not only cuts down on processing time but also maintains high fidelity in predicting solutions, thereby outperforming conventional computational techniques.

### FIGS. 4A-C—Example U-Net Architectures

Several example configurations of the U-Net Architectures are shown in FIGS. 4A-C. The figures show the input forcing function, the neural network structure, and the solution. Each tile represents the features that come from processing the output of the preceding layer with its activation function and batch normalization. Skip connections are shown as horizontal lines connecting features at different strides of the encoder portion to their corresponding strides in the decoder portion. FIG. 4A shows an architecture with an initial feature count of 2 (ƒ=2), five scale changes (d=5), and a stack of one (s=1, i.e., a single U-Net). FIG. 4B shows a network with ƒ=4, d=4, and s=1. Compared with the first model, this one has increased width in the encoding layers, but processes features at fewer scales. FIG. 4C shows the U-Net with two stacks (s=2), initial features (ƒ=8), and scale changes (s=4).

The configurable U-Net characteristics are shown in Table 1, below.

TABLE 1

| | Original | Configurable |
|---|---|---|
| Parameters | U-Net | U-Net |
| Initial | 8 | 2-8 |
| Features (f) | | |
| Stack (s) | 1 | 1-3 |
| Scale Changes | 3 | 3-5 |
| (d) | | |
| Pooling Type | Max | Max/Average |
| Activation | RelU | Relu/Elu |
| Type | | |

### Workflow for Training and Operating a Neural Network Elliptical Solver

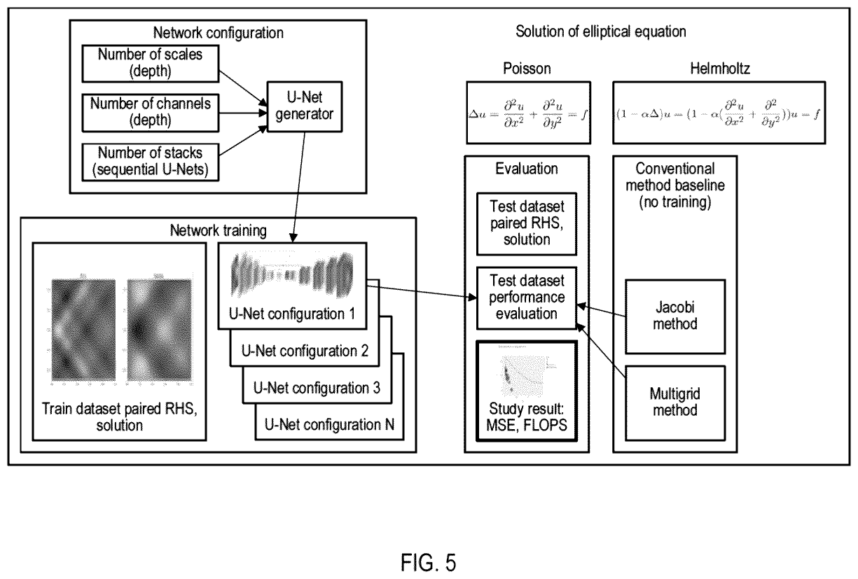

FIG. 5 illustrates the workflow for the proposed U-Net architecture, according to some embodiments. In particular, FIG. 5 illustrates how a network configuration may be utilized to generate a particular U-net architecture. Multiple different configurations may be separately utilized in network training in conjunction with paired initial conditions and known solutions. The trained neural network may then be utilized to obtain the solution to a Poisson and/or Helmholtz equation.

### Poisson Equation Dataset

The 2-D Poisson equation is given as:

$$Δ u = \frac{{\partial }^{2} u}{\partial {x}^{2}} + \frac{{\partial }^{2} u}{\partial {y}^{2}} = f \qquad ( 9 )$$

where, u=u(x,y) is a scalar variable defined on the 2-D spatial domain. Here, ƒ is the right-hand-side or the forcing functions of the Poisson Equation.

In some embodiments, the dataset is trained such that it captures the features of the physical system, and thus the characteristics of the datasets used as training data plays a fundamental role in developing the U-Net model. The neural network learns to reproduce the mathematical features of the datasets. A synthetic data set may be generated such that the data is a random combination of low-frequency and high-frequency waves in a periodic domain. For a given domain, an large number of possible solutions may be constructed which satisfy the equations and boundary conditions using a combination of sinusoidal and cosine periodic functions. The training data for the solution and the forcing function of the Poisson equation used is as follows:

$$u = {\sum }_{n = 1}^{9} {a}_{n} sin ( n π x ) cos ( n π y ) f = {\sum }_{n = 1}^{9} {a}_{n} \frac{- {a}_{n}}{( 2 {n}^{2} {π}^{2} )} sin ( n π x ) cos ( n π y ) x ∈ [ 0 , 1 ] , y ∈ [ - \text{.5} , \text{.5} ] \qquad ( 10 )$$

Here, u is the 2-D solution of the Poisson Equation (Eq. 9), ƒ is the 2-D forcing function in the (x,y) domain, and a is the random function.

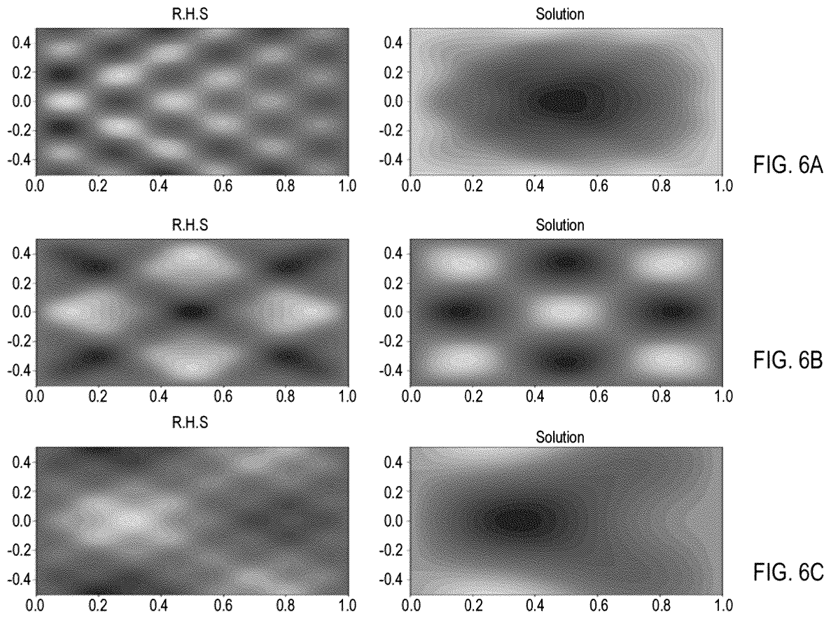

FIGS. 6A-C illustrate training data for the Poisson Equation Δu=ƒ. In each of FIGS. 6A-C, the left side image shows the forcing function (ƒ) of Eq. 9, and the right side image illustrate the solution (u). FIGS. 6A, 6B and 6C illustrate three instances of the training data showing a variation of the scales used to train the system.

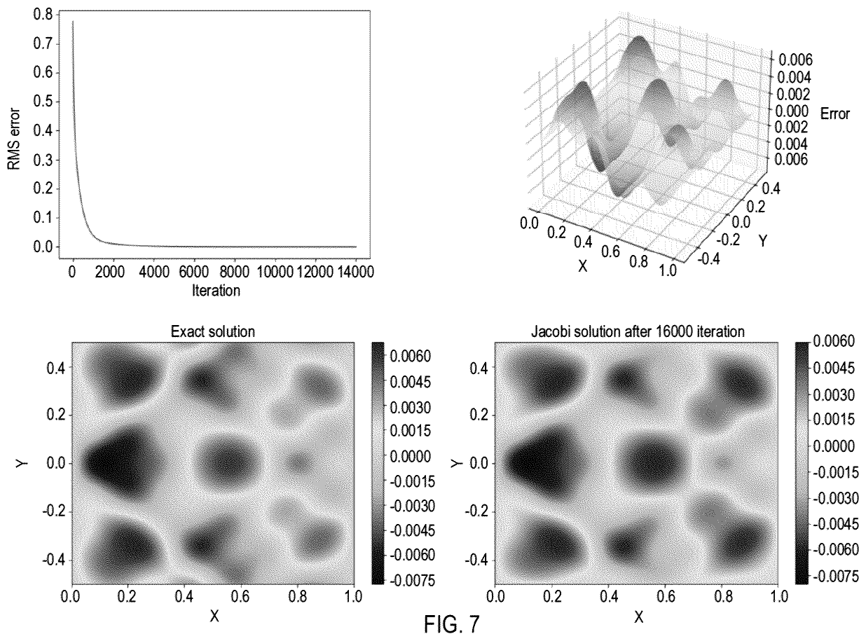

To generate the synthetic test and training data, the coefficients may be selected at random, sampling from a uniform distribution ranging from 0 to 1. To create a distinction between the dataset's training mode and testing mode, the test set may be defined by assigning a random seed to each element, ensuring that all comparisons of test data are made against the same data. FIGS. 6A-C show a wide range of forcing functions of the Poisson equation and the corresponding solutions used to train the solver. The top left image in FIG. 7 shows the convergence of the Jacobi solution vs. iterations for an instance of the training data. The error reduces to an order of 10⁻³ in around 2000 iterations. The surface plot of the residue (Eq. 8) is shown in the top right image in FIG. 7. The residue has a similar structure as the solution as seen in the bottom left image in FIG. 7, which shows the exact solution and the numerical solution after 16,000 iterations. The numerical solution shown in the bottom right image of FIG. 7 matches the exact solution, as expected.

### Helmholtz Equation

The 2-D Helmholtz equation is given as:

$$( 1 - α Δ ) u = ( 1 - α ( \frac{{\partial }^{2} u}{\partial {x}^{2}} + \frac{{\partial }^{2}}{\partial {y}^{2}} ) ) u = f \qquad ( 11 )$$

where, u=u(x,y) is a scalar variable and ƒ is the forcing function defined in the 2-D domain. The training data for the solution and the forcing function of the Helmholtz equation, Eq. 11 is:

$$u = {\sum }_{n = 1}^{9} {s}_{n} sin ( n π x ) cos ( n π y ) f = {\sum }_{n = 1}^{9} ( 1. + α 2 {n}^{2} {π}^{2} ) * {s}_{n} * sin ( n π x ) cos ( n π y ) x ∈ [ 0 , 1 ] , y ∈ [ - \text{.5} , \text{.5} ] \qquad ( 12 )$$

Here, s is a random function, and α=0.1

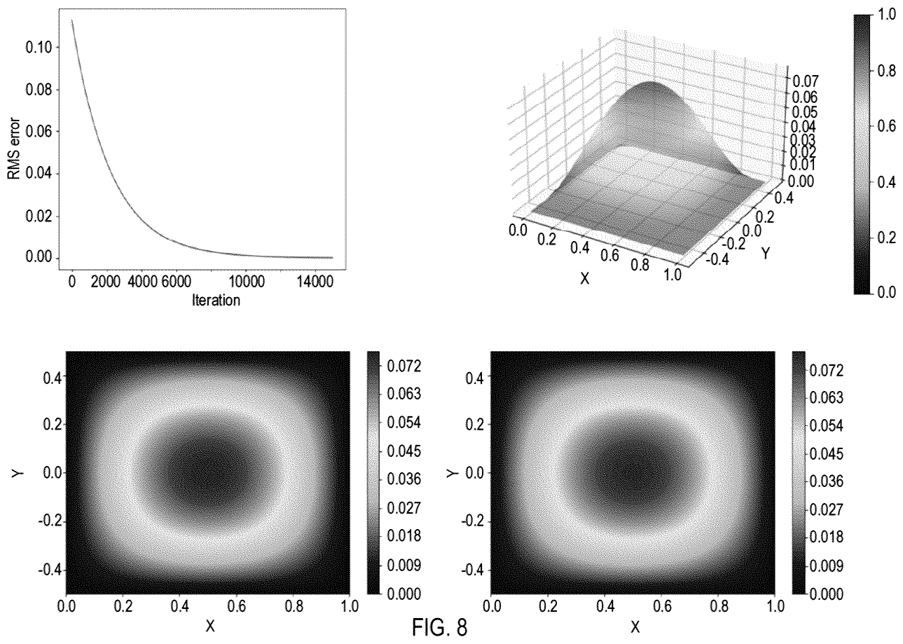

The numerical solution of the Helmholtz Equation (Eq. 11) obtained using the Jacobi solver is shown in FIG. 8. The top left image of FIG. 8 shows the convergence of the Jacobi solution vs. iterations for an instance of the training data. The error reduces to an order of 10-3 in around 8000 iterations. The surface plot of the residue (Eq. 8) is shown in the bottom right image of FIG. 8. The residue has a similar structure as the solution. The bottom right image in FIG. 8 shows the exact solution and the bottom left image in FIG. 8 shows the numerical solution after 12,000 iterations. The numerical solution matches the exact solution, as expected.

### Model Training

In some embodiments, the models are trained using a mean-squared error (MSE) loss function which aggregates the loss over every pixel in the training batch. Mean squared error is calculated as the average of the squared differences between the predicted and actual values. Each model configuration may be trained using the Adam solver, which is an algorithm for first-order gradient-based optimization of stochastic objective functions, based on adaptive estimates of lower-order moments. The iterations may be performed over 120 epochs (where each epoch contains 10000 randomly-generated right-hand-side/solution pairs). The initial learning rate used was E⁻³ and an exponential learning rate decay (γ=0.95) was applied after each epoch. Eq. 3.4 shows the training data that was used to train the Poisson solver. The function is a linear combination of high-frequency and low-frequency waves to represent the multi-scale features of a flow. A few sample features of the training data of the solution and the corresponding forcing function is shown in FIGS. 6A-C.

The accuracy of the architecture has been monitored using a L₂ norm, defined as:

$${L}_{i} = \frac{1}{n} {\sum }_{i} {( {u}_{i} - {u}_{e} )}^{2} \qquad ( 13 )$$

where, Lᵢ is the 2-norm error, uₑ is the exact solution.

### Computational Time and Error Analysis

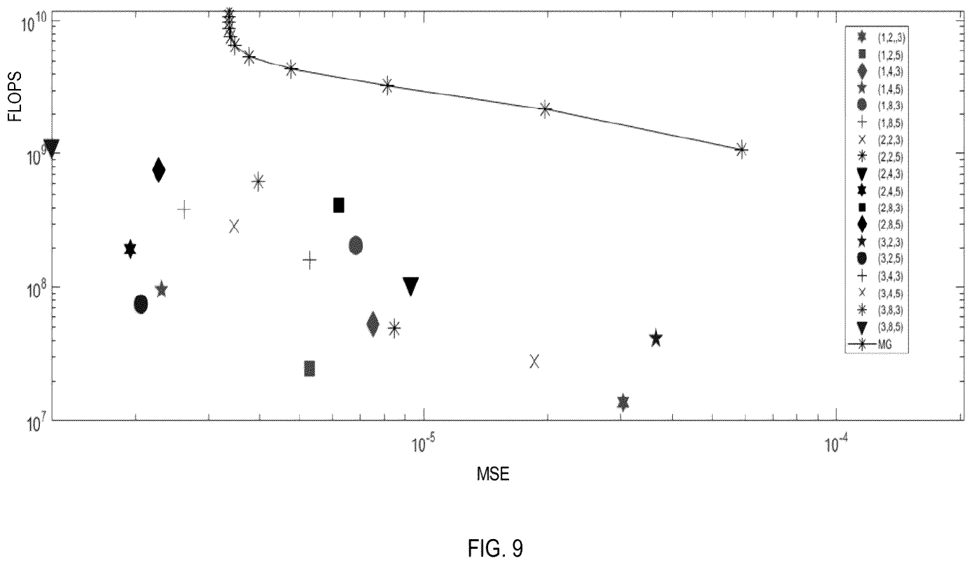

To compare the computational time between the different architectures, a measure, namely, the number of Floating-point-operations (FLOPS) has been used. As this is a metric used to calculate the computational complexity of Neural network models. FLOPS is a unit of measurement that quantifies the number of floating-point calculations a computer or processor can perform in a second. It is a straight forward metric to compare the number of arithmetic operations required to achieve a desired level of convergence. FIG. 9 is a plot that compares the different Architecture Space Parameters shown in Table 1. Also shown is the solution from the multigrid solver for specified convergence criteria. The FLOPS is shown on the y axis and the MSE on the x axis. Overall, the performance of all the U-Nets is better than the MG in terms of the FLOPS. The notation of the architecture is represented by the triplet: (s,ƒ,d). The lowest MSE is for (3,8,5) which corresponds to 3 stacks, 8 initial features and 5 scales with ELU activation function, however the computational efficiency is the highest of all the cases. The optimal performance between the errors and the FLOPS is the (3,2,5) case. The cases of (1,4,5) and (2,4,5) have similar optimal performance. The cases of (1,2,3) and (3,2,3) have the highest MSE of all the cases. With a single stack U-Net, (1,4,5) has the lowest error and (1,2,3) has the highest error. With two U-Net stacks, the errors are much less than a single stack U-Net. By increasing the stacks to 3, the error decreases further with 5 scale-factors. Overall, the architecture with 3 stacks, 2 initial features and 5 scale changes is most efficient and accurate U-Net architecture for Poisson solver.

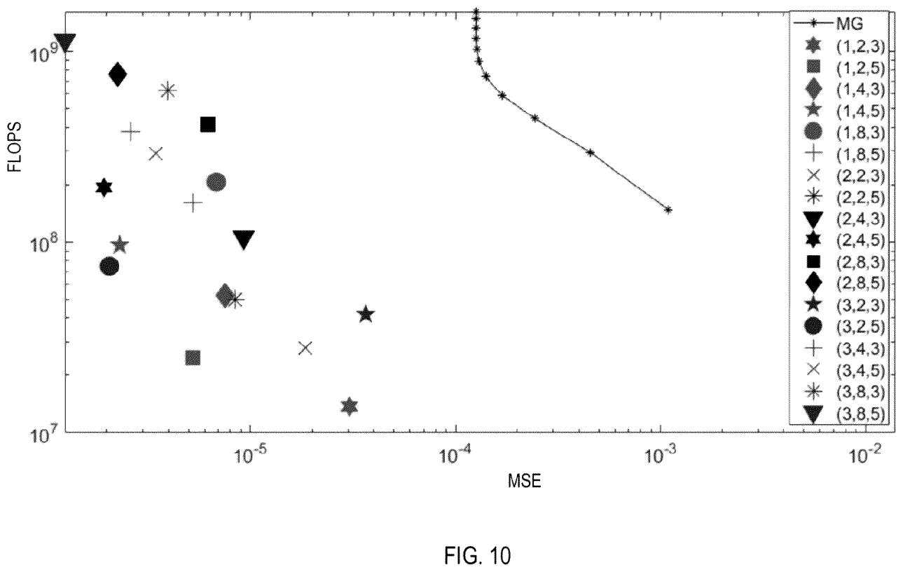

A similar analysis has been conducted for the Helmholtz solver, as shown in FIG. 10. The performance of the multigrid for the Poisson and Helmholtz equations are different. This is expected as the condition of the discretized matrix A in Eq. 8 is diagonally dominant for the Helmholtz equation (Eq. 11) compared to the Poisson equation (Eq. 9). The difference in the matrix condition significantly impacts the convergence of the Poisson vs. Helmholtz solvers. However, it appears that the U-Net is able to capture the mathematical characteristics of both the elliptical equations with the same level of fidelity. The performance of the U-net is very similar with the Poisson solver. The optimal performance between the errors and the FLOPS is the (3,2,5) case. There was significant difference in the numerical performance between the architectures with a FLOPS varying between 10⁷ to 10⁹ and the error varying between 5×10⁻⁴-10⁻⁶.

### CONCLUSIONS

Multigrid methods (MG) are established techniques for solving Elliptical Partial Differential Equations (PDEs) using a strategy of recursively solving the residual equation of a Jacobi solver on series of grids. In the V-cycle of the MG, the underlying idea is that as the high frequency errors can be eliminated quickly and it is the low frequency errors that slow the convergence, hence by transferring the error equation to a coarser grid, on which smooth becomes rough and low frequencies act like higher frequencies, an overall fast convergence is achieved through this recursive process. Similarly, the U-Net Neural Network architecture is a symmetric U-shaped network for encoding and decoding with hierarchical levels. It recovers information lost during convolutional down-sampling, as the spatial scales are traded to the semantic features during the encoding. The semantic knowledge adds the spatial features during the decoding stage. This feature is exploited in embodiments herein to train an optimized U-Net architecture to capture the mathematical features of an elliptical partial differential equation. Using a stacked U-Net has improved the computational performance as the data passes through the multiple U-Net blocks, the high-resolution features are mixed with the low-resolution context information and they are processed through multiple layers to produce informative and high-resolution features. The stacked U-Net models utilize fewer feature maps per layer than conventional architectures, and thus they achieve a higher performance with far fewer parameters.

The described U-Net Neural Networks are a superior alternative to the conventional methods for solving the elliptical PDEs. Advantageously, the architecture can seamlessly capture the mathematical properties of the elliptical operator irrespective of the condition number of the matrix.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A computer-implemented method for determining dynamical behavior of a fluid, the computer-implemented method comprising:
receiving a network configuration for training a neural network model;
training the neural network model using a training dataset, wherein training the neural network is performed for a plurality of layers, wherein a first layer of the plurality of layers receives a set of initial conditions of the fluid as input and outputs a first output, wherein each layer of the plurality of layers after the first layer receives as input an output of a preceding layer, wherein the plurality of layers exhibit a ramping down of a spatial resolution between layers followed by a ramping up of the spatial resolution between layers, wherein each layer during the ramping down of the spatial resolution provides features to a corresponding layer with a same spatial resolution during the ramping up of the spatial resolution;
receiving a test dataset representing mathematical characteristics of an elliptical partial differential equation describing dynamical aspects of the fluid;
numerically solving the elliptical partial differential equation using the trained neural network model to determine a solution of the elliptical partial differential equation;
determining the dynamical behavior of the fluid based at least in part on the solution of the elliptical partial differential equation; and
storing the dynamical behavior of the fluid in a non-transitory computer-readable memory medium.

2. The computer-implemented method of claim 1,
wherein training the neural network model using the training dataset is performed according to a plurality of U-net architectures.

3. The computer-implemented method of claim 1,
wherein the elliptical partial differential equation comprises a Poisson equation or a Helmholtz equation.

4. The computer-implemented method of claim 3,
wherein the Poisson equation comprises a pressure Poisson equation for an incompressible or compressible fluid.

5. The computer-implemented method of claim 1,
wherein the training dataset comprises a randomized set of waves with a plurality of distinct frequencies in a periodic domain.

6. The computer-implemented method of claim 1,
wherein training the neural network model comprises minimizing a mean-squared error (MSE) loss function which aggregates a loss over pixels in the training dataset.

7. The computer-implemented method of claim 1,
wherein the solution of the elliptical partial differential equation comprises a numerical description of multi-scale features of an elliptical operator of the elliptical partial differential equation.

8. The computer-implemented method of claim 1,
wherein each layer of the plurality of layers extracts features of an elliptical operator of the elliptical partial differential equation at a respective spatial resolution of the respective layer.

9. The computer-implemented method of claim 1,
wherein the plurality of layers further exhibits at least one second ramping down of the spatial resolution between layers followed by at least one second ramping up of the spatial resolution between layers.

10. The computer-implemented method of claim 1,
wherein training the neural network model comprises implementing an average pooling function on features extracted for each layer of the plurality of layers.

11. The computer-implemented method of claim 1,
wherein the trained neural network model exhibits a reduced computational cost compared to iterative multigrid methods at a corresponding spatial resolution.

12. The computer-implemented method of claim 1,
wherein the fluid comprises a compressible or incompressible fluid with a Reynolds number indicative of turbulent flow.

13. The computer-implemented method of claim 1,
wherein the dynamical behavior of the fluid comprises one of:
a flow of air over a terrestrial vehicle or aircraft;
a flow of a liquid through a pipe; or
a flow of one or more atmospheric layers over land.

14. A non-transitory computer-readable memory medium storing program instructions which, when executed by a processor, cause a computing device to:
receive a network configuration for training a neural network model;
train the neural network model using a training dataset, wherein training the neural network is performed for a plurality of layers, wherein a first layer of the plurality of layers receives a set of initial conditions of a fluid as input and outputs a first output, wherein each layer of the plurality of layers after the first layer receives as input an output of a preceding layer, wherein the plurality of layers exhibit a ramping down of a spatial resolution between layers followed by a ramping up of the spatial resolution between layers, wherein each layer during the ramping down of the spatial resolution provides features to a corresponding layer with a same spatial resolution during the ramping up of the spatial resolution;
receive a test dataset representing mathematical characteristics of an elliptical partial differential equation describing dynamical aspects of the fluid;
numerically solve the elliptical partial differential equation using the trained neural network model to determine a solution of the elliptical partial differential equation;
determine dynamical behavior of the fluid based at least in part on the solution of the elliptical partial differential equation; and
store the determined dynamical behavior of the fluid in the non-transitory computer-readable memory medium.

15. The non-transitory computer-readable memory medium of claim 14,
wherein training the neural network model using the training dataset is performed according to a plurality of U-net architectures.

16. The non-transitory computer-readable memory medium of claim 14,
wherein the elliptical partial differential equation comprises a Poisson equation or a Helmholtz equation, and
wherein the Poisson equation comprises a pressure Poisson equation for an incompressible or compressible fluid.

17. The non-transitory computer-readable memory medium of claim 14,
wherein the training dataset comprises a randomized set of waves with a plurality of distinct frequencies in a periodic domain.

18. A computing device, comprising:
a processor;
a non-transitory computer-readable memory medium storing program instructions which, when executed by the processor, cause the computing device to:
receive a network configuration for training a neural network model;
train the neural network model using a training dataset, wherein training the neural network is performed for a plurality of layers, wherein a first layer of the plurality of layers receives a set of initial conditions of a fluid as input and outputs a first output, wherein each layer of the plurality of layers after the first layer receives as input an output of a preceding layer, wherein the plurality of layers exhibit a ramping down of a spatial resolution between layers followed by a ramping up of the spatial resolution between layers, wherein each layer during the ramping down of the spatial resolution provides features to a corresponding layer with a same spatial resolution during the ramping up of the spatial resolution;
receive a test dataset representing mathematical characteristics of an elliptical partial differential equation describing dynamical aspects of the fluid;
numerically solve the elliptical partial differential equation using the trained neural network model to determine a solution of the elliptical partial differential equation;
determine dynamical behavior of the fluid based at least in part on the solution of the elliptical partial differential equation; and
store the determined dynamical behavior of the fluid in the non-transitory computer-readable memory medium.

19. The computing device of claim 18,
wherein training the neural network model using the training dataset is performed according to a plurality of U-net architectures.

20. The computing device of claim 18,
wherein the elliptical partial differential equation comprises a Poisson equation or a Helmholtz equation, and
wherein the Poisson equation comprises a pressure Poisson equation for an incompressible or compressible fluid.
